(19) United States
(12) Patent Application Publication
(10) Pub. No.: US 2016/0221634 A1
(43) Pub. Date: Aug. 4, 2016

(54) ELECTRIC MOTORIZED BICYCLE COMPONENTS AND A WIRELESS CONTROL SYSTEM INCLUDING SUCH

(71) Applicant: SSI America, Inc., Fort Lauderdale, FL (US)

(72) Inventors: James BUCHHEIM, AVENTURA, FL (US); Arne HENNIG, Davie, FL (US); Jeremy BRIGGS, San Diego, CA (US)

(21) Appl. No.: 14/960,469

(22) Filed: Dec. 7, 2015

Related U.S. Application Data
(63) Continuation of application No. 13/391,292, filed on Feb. 20, 2012, now abandoned.
(60) Provisional application No. 61/235,382, filed on Aug. 20, 2009.
(60) Provisional application No. 61/238,759, filed on Sep. 1, 2009.

(51) Int. Cl. B62M 6/50; B60B 1/00; B62M 1/36; B62M 6/65; B62M 6/90

(52) U.S. Cl. CPC B62M 6/50; B62M 6/65; B62M 6/90; B62M 1/36; B60B 1/003

(57) ABSTRACT

An electric power assist system for use with a pedal vehicle. The system has (a) an electric motorized wheel including a plurality of spokes extending from the motor housing to the rim, at least one the spoke configured so as to define within it a battery compartment in which at least one power supply battery is deployed, wherein the battery compartment lies in the planer region substantially defined by the outer sides of the rim; (b) a wireless throttle control in RF communication with the wheel; and (c) a wireless pedal assist sensor in RF communication with the wheel and configured to detect movement of pedals of the pedal vehicle and transmit command signals to the wheel so as to start power assist operation, and to stop the power assist operation as determined by the movement of the pedals.

### FIELD AND BACKGROUND OF THE INVENTION

The present invention relates to motorized bicycle components and, in particular, it concerns an electric motorized bicycle wheel having the power supply batteries mounted within compartments configured in the spokes and a system including such a wheel together with a wireless speed control and/or a wireless PAS (pedal assist sensor).

It is known to provide electric power assist bicycles with hub motors. Generally, wheels having hub motors are configured with conventional spokes or solid wheels.

The versions having solid wheels typically utilize the empty space within the wheel shell for the deployment of components such as controllers and batteries. The majority of the wheel shell is wider than the rim of the wheel on which the tire is deployed.

The versions having conventional spokes typically have such components deployed off the wheel or on special structures on the wheel whose sole purpose is to hold these components and which do not support the bicycle.

Also common to current electric power assist bicycle systems are the wires required to connect the various control components such as the speed control to the main system control module. These wires add to the amount of time needed and the difficulty of initial installation and changing the electric power assist bicycle system to another bicycle.

There is therefore a need for an electric motorized bicycle wheel having the power supply batteries mounted within compartments configured in the spokes and a system including such a wheel together with a wireless speed control and/or a wireless PAS.

### SUMMARY OF THE INVENTION

The present invention is an electric motorized bicycle wheel having the power supply batteries mounted within compartments configured in the spokes and a system including such a wheel together with a wireless speed control and/or a wireless PAS. According to the teachings of the present invention there is provided, an electric power assist system for use with a pedal vehicle, the system comprising: (a) an electric motorized wheel including a plurality of spokes extending from the motor housing to the rim, at least one the spoke configured so as to define within it a battery compartment in which at least one power supply battery is deployed, wherein the battery compartment lies in the planer region substantially defined by the outer sides of the rim; (b) a wireless throttle control in RF communication with the wheel; and (c) a wireless pedal assist sensor in RF communication with the wheel and configured to detect movement of pedals of the pedal vehicle and transmit command signals to the wheel so as to start power assist operation, and to stop the power assist operation as determined by the movement of the pedals.

According to a further teaching of the present invention, each the spoke includes two substantially parallel side spokes and two spoke compartment covers that extend between the side spokes, thereby defining within them the battery compartment.

According to a further teaching of the present invention, the wireless pedal assist sensor includes an accelerometer and when the accelerometer detects that the pedals of the pedal vehicle are moving in a direction that indicates forward movement of the pedal vehicle, the transmitter send a command signal to a motor control system to start power assist operation, and when the accelerometer detects that movement of the pedals has stopped or that the pedal movement is in a wrong direction, the transmitter sends a command signal to stop the power assist operation.

There is also provided according to the teachings of the present invention, an electric motorized wheel for use with a vehicle, the wheel comprising: (a) an axle for mounting the wheel on the vehicle; (b) an electric hub motor mounted so as to circumscribe the axle, the electric hub motor encased in a motor housing; (c) a rim upon which, a tire and inner tube are mounted; and (d) a plurality of spokes extending from the motor housing to the rim, at least one the spoke configured so as to define within it a battery compartment in which at least one power supply battery is deployed; wherein the battery compartment lies in the planer region substantially defined by the outer sides of the rim.

According to a further teaching of the present invention, each the spoke includes two substantially parallel side spokes and two spoke compartment covers that extend between the side spokes, thereby defining within them the battery compartment.

According to a further teaching of the present invention, the electric hub motor is configured such that fixed magnets are mounted on a stationary hub portion and electro-magnets are mounted on a rotating portion of die wheel.

According to a further teaching of the present invention, the spokes are substantially rectangular.

There is also provided according to the teachings of the present invention, a wireless pedal assist sensor for use with a power assisted pedal vehicle, the pedal assist sensor comprising: (a) a processing chip; (b) an accelerometer in electrical communication with the processing chip; (c) transmitter in electrical communication with the processing chip; (d) an antenna connected to the transmitter; and (e) a battery; wherein when the accelerometer detects that the pedals of the pedal vehicle are moving in a direction that indicates forward movement of the pedal vehicle, the transmitter send a command signal to a motor control system to start power assist operation, and when the accelerometer detects that movement of the pedals has stopped or that the pedal movement is in a wrong direction, the transmitter sends a command signal to stop the power assist operation.

According to a further teaching of the present invention, the transmitter is a 2.4 GHz RF transmitter.

According to a further teaching of the present invention, the accelerometer is configured to detect both motion and direction.

There is also provided according to the teachings of the present invention, method for monitoring a plurality of individual batteries in an electric power assist system for use with a pedal vehicle, the method comprising: (a) individually monitoring at least one of battery temperature, battery output and battery intake for each battery in the plurality of batteries in the electric power assist system; (b) disconnecting from the electric power assist system any individual battery in the plurality of batteries in the electric power assist system that experiences a malfunction in any on of the battery temperature, the battery output and the battery intake while maintaining connection to any of the individual batteries in the plurality of batteries in the electric power assist system that is functional.

According to a further teaching of the present invention, there is also provided: (a) providing a battery monitoring system configured to monitor each of the individual batteries in the plurality of batteries in the electric power assist system as an independent entity; and (b) controlling each individual battery based on a current operational status of the individual battery.

According to a further teaching of the present invention, the controlling implemented when the current operational status of different ones of the individual batteries in the plurality of batteries indicates that different ones of the individual batteries have differing charge levels.

### BRIEF DESCRIPTION OF THE DRAWINGS

The invention is herein described, by way of example only, with reference to the accompanying drawings, wherein:

FIG. 1 is an isometric view of an electric motorized bicycle wheel constructed and operational according to the teachings of the present invention;

FIG. 2A is a side elevation of the installation of the electric motorized bicycle wheel of FIG. 1 on a bicycle;

FIG. 2B is a side elevation of the electric motorized bicycle of FIG. 2A when fully assembled;

FIG. 3 is an exploded isometric view of the decide motorized bicycle wheel of FIG. 1;

FIG. 4 is a detail of the electric motorized bicycle wheel of FIG. 1 showing the recharge connection configured in one of the spokes;

FIG. 5 is front elevation of the wheel of FIG. 1;

FIG. 6 is an isometric view of the wheel of FIG. 1;

FIG. 7 is an isometric view of a wireless throttle constructed and operational according to the teachings of the present invention;

FIG. 8 is an isometric view of a wireless PAS cons and operational according to the teachings of the present invention; and

FIG. 9 is a schematic block drawing of the PAS of FIG. 8.

### DESCRIPTION OF THE PREFERRED EMBODIMENTS

The present invention is an electric motorized bicycle wheel having the power supply batteries mounted within compartments configured in the spokes and a system including such a wheel together with a wireless speed control and/or a wireless PAS.

The principles and operation of electric motorized bicycle components according to the present invention may be better understood with reference to the drawings and the accompanying description.

By way of introduction, the electric components of the present invention when used together provide an unique electric power assist system the is well suited for use with bicycles, however, the features and principles of the present invention may be applied with equal benefit to wheels for use with other vehicles such as, but not limited to, wheel chairs, tricycles and even cars and motorcycles. Furthermore, each of the components may be used individually as well.

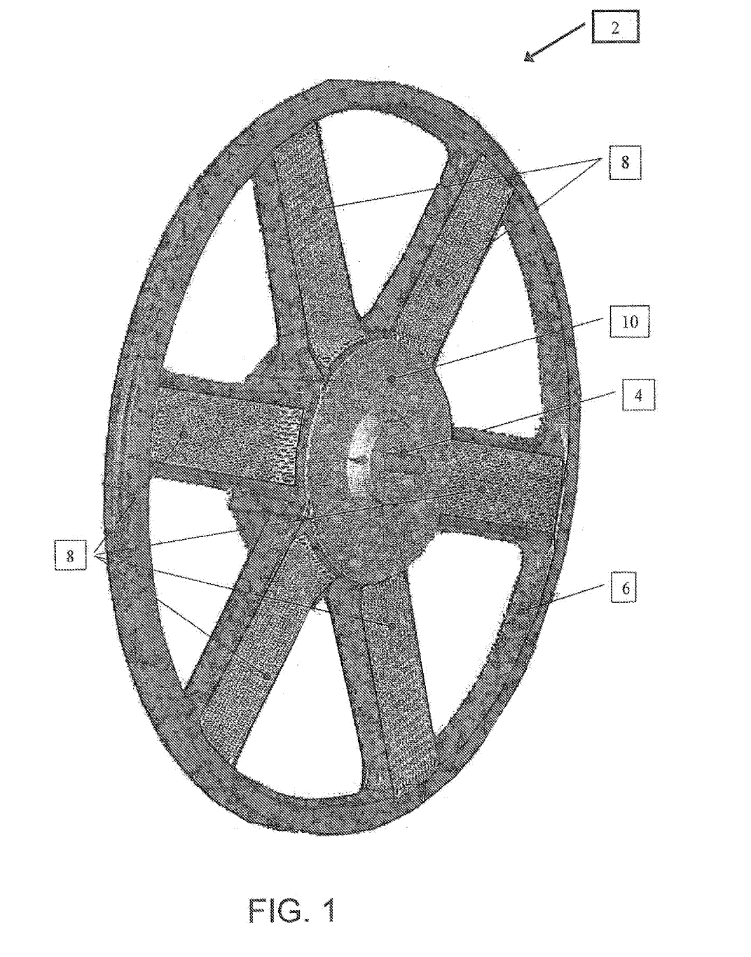

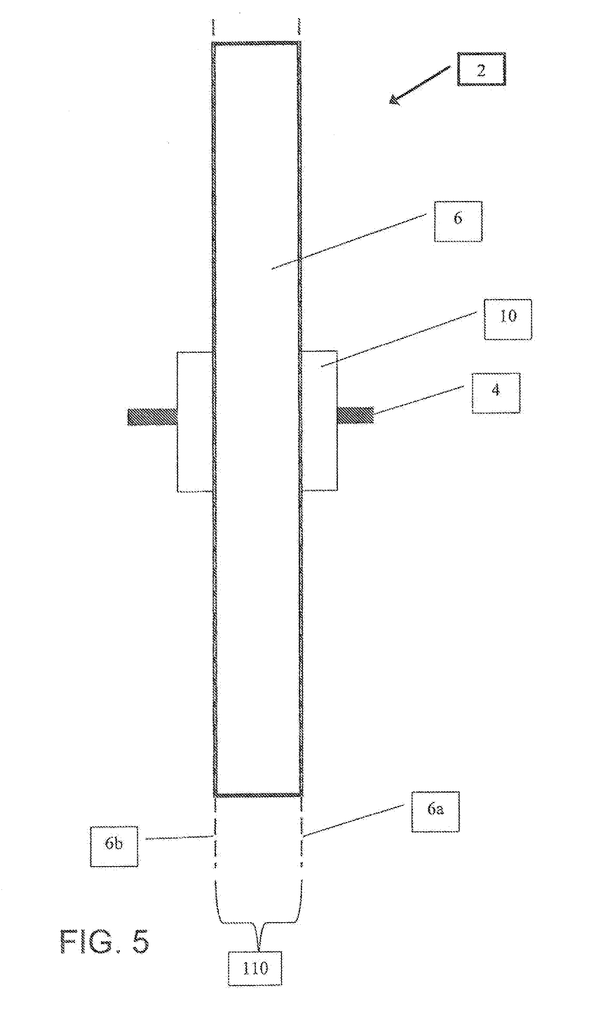

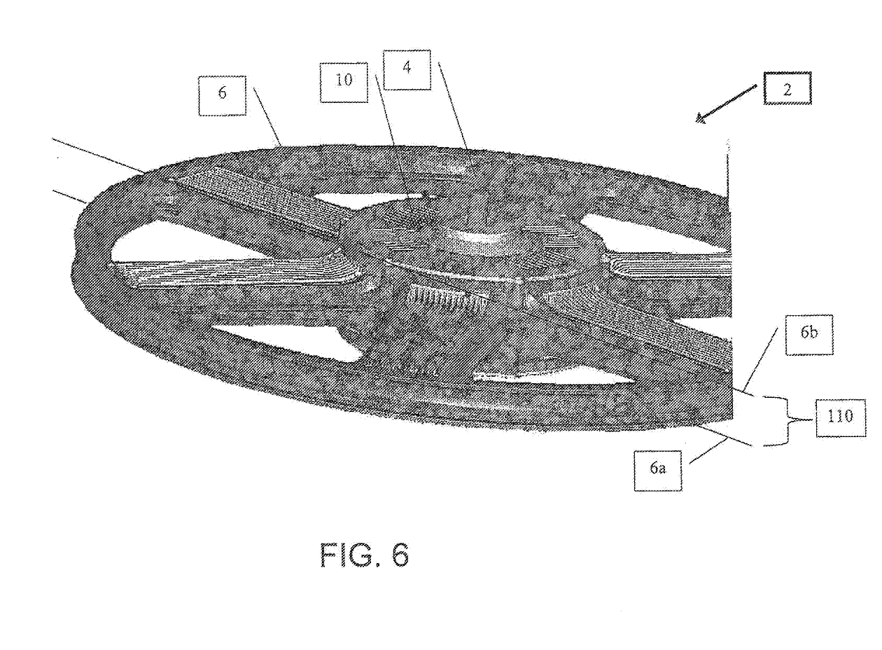

Referring now to the drawings, the illustrative example of an electrically powered wheel and power assist system according to the present invention is shown in FIGS. 1-6.

As illustrated in FIG. 1, the wheel itself includes a hub motor 10 similar to those currently being used with electric powered bicycles, an axle 4 for mounting the wheel 2 on the bicycle 100, a rim 6 upon which the tire and inner tube are mounted and a plurality of substantially rectangular spokes 8 extending from the motor housing to the rim 6.

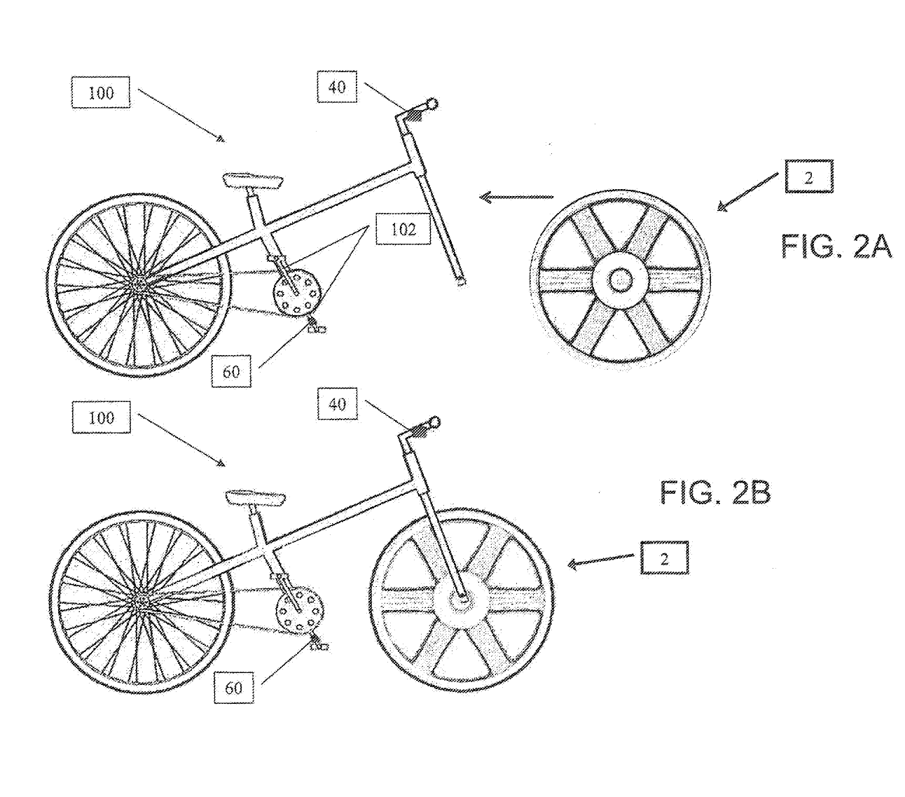

As illustrated here, the wheel 2 does not include a gear set and is therefore indented for use as the front wheel of a bicycle (FIG. 2). This, however, is not intended as a limitation and the use of the wheel of the present invention, in combination with a gear set, as the rear wheel of a bicycle is within the scope of the present invention.

That said, one of the intentions of the present invention is to provide a motorized bicycle wheel 2 that is substantially self contained and simple to install and/or change from one bicycle to another with ease (FIG. 2A). To that end, the axle 4 is preferably, but not necessarily, configured with a quick release lever as in know in the art.

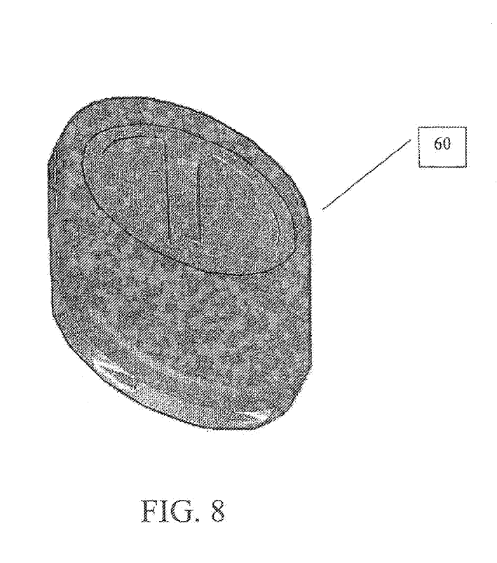

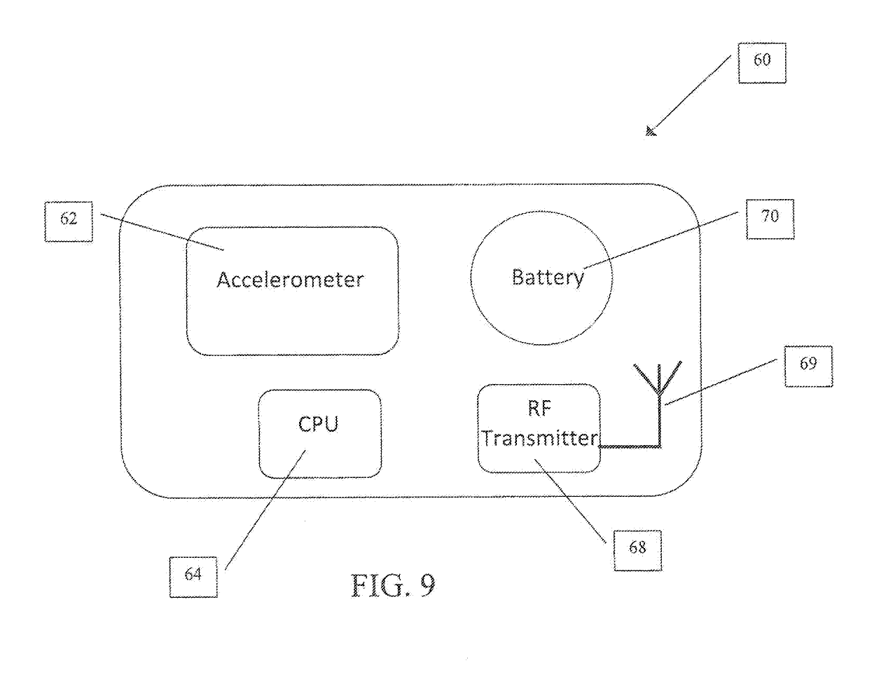

Ease of installation of the entire system is enhanced by the use of wireless communication between the motor controller and the throttle 40 (speed control) and/or PAS sensor 60, discuss in more detail with regard to FIGS. 8 and 9.

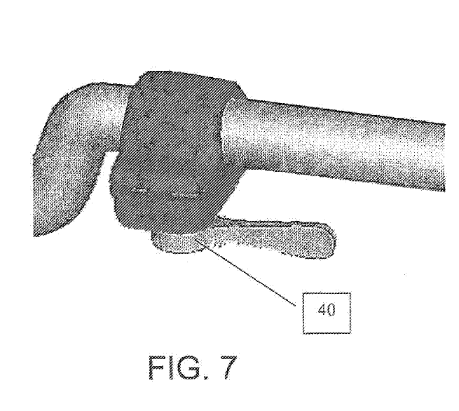

As illustrated in FIG. 7, the wireless throttle 40, which in this embodiment is thumb operated, may be installed by merely sliding the case over the handlebar and forcing it shut until it clicks closed. Alternatively, the throttle housing may be mounted on the handlebars by the use of hook and loop connectors, zip-ties, screws or substantially any suitable method.

Similarly, the PAS 60, which includes an accelerometer, may be installed on either pedal crank arm 62 by use of hook and loop connectors, zip-ties or the like (FIGS. 2A and 2B).

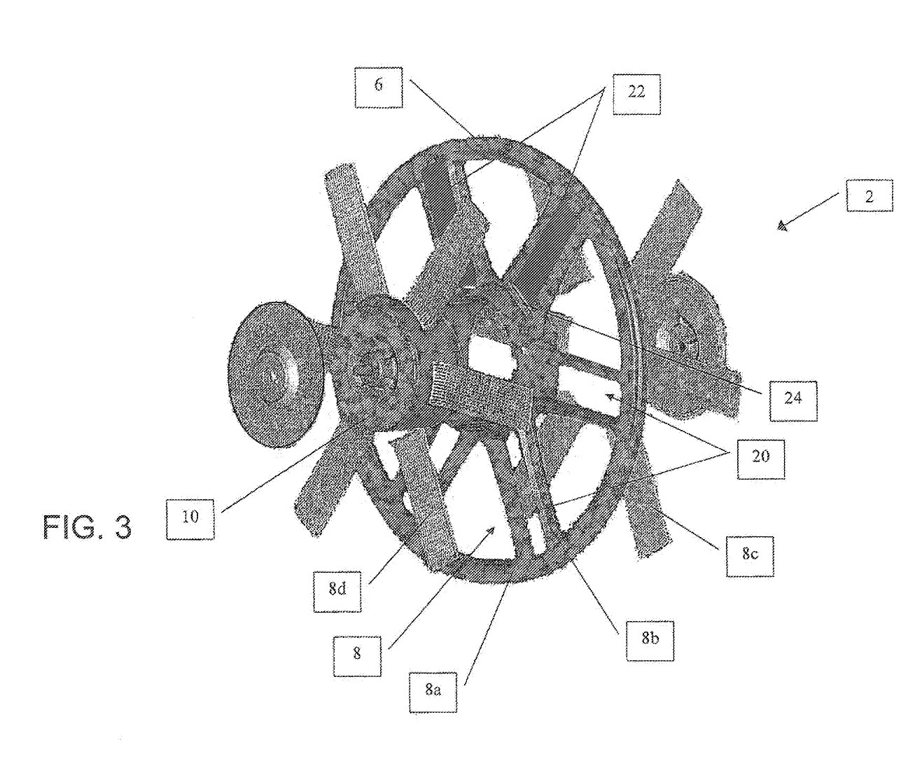

The exploded view of FIG. 3 shows the battery compartments 20 configured inside the rectangular spokes 8 with batteries 22 illustrated mounted in two of them. It should be noted that the term “rectangular” is used herein with respect to the shape of the large spoke as illustrated in the current drawings, however, it is not intended as a limitation to the present invention and it is within the scope of the present invention to provide spokes having any suitable outer shape or cross-section contour.

As seen here, each large spoke 8 is made up of two substantially parallel side spokes 8a and 8b and two spoke compartment covers 8c and 8d that extend between the side spokes 8a and 9b. This configuration creates an interior spoke compartment 20 into which batteries 22, a controller board 24 and/or a battery charging arrangement 30 may be deployed.

Therefore, at least the batteries 22, and preferably the controller board 24 and/or a battery charging arrangement 30, are deployed on the wheel 2 between the hub motor housing 10 and the rim 6, in compartments configured in the spokes 8 of the wheel. The interior spoke compartment 20 into which batteries 22 and other components are deployed lie in the planer region 110 substantially defined by the outer sides 6a and 6b of the rim 6.

Since the power source (batteries) is located on the rotating portion of the wheel, the electric motor is configured such that the fixed magnets are mounted on the stationary hub portion and the electro-magnets are mounted on the rotating portion of the wheel. It should be noted that the use of a geared motor arrangement is within the scope of the present invention.

The wheel of the present invention illustrated here has six such large spokes 8. Such an array could be configured with batteries 22 installed in five spokes 8 and the controller 24 and battery charging arrangement 30 installed in the sixth spoke 8.

It should be noted that it is within the scope of the present invention to vary the number of spokes to any suitable number and that the controller 24 and battery charging arrangement 30 need not require a dedicated spoke.

It should also be noted that any unused space within battery compartments 20 may be used for deployment and/or storage of substantially anything. Therefore, a non-motorized wheel in which the compartments 20 are provided with easily open compartment doors so as to allow for storage of miscellaneous items of the riders choosing such as, but not limited to, tire and bicycle repair parts and tools, tire pump and personal items, is within the scope of the present invention.

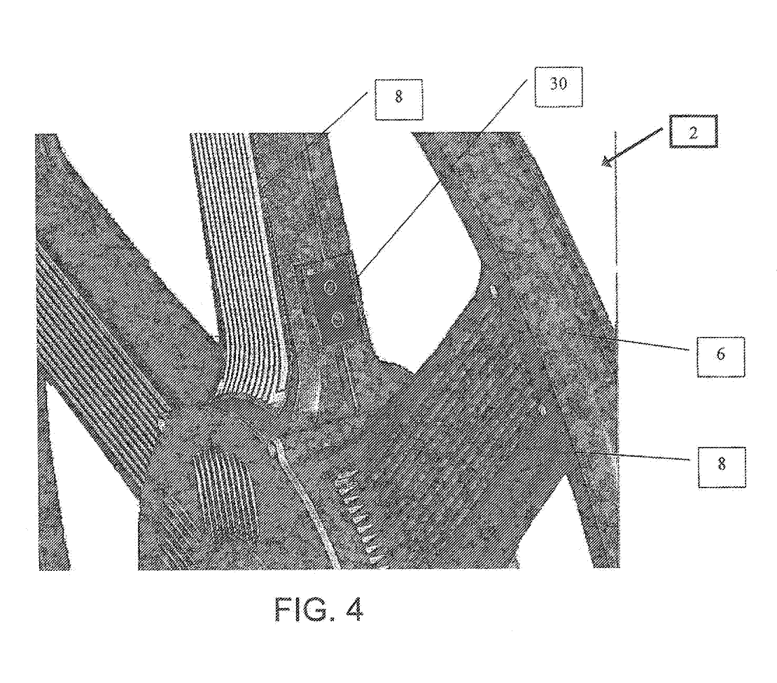

The battery charging arrangement 30 (FIG. 4) may be such that the charging unit is installed in the wheel 2. Alternatively, the charging unit may be incorporated into the wire that is plugged into the wall outlet.

In Europe, and other locations, a power assisted vehicle such as the electric bicycle 100 of FIG. 2B must have a PAS 60 (Pedal Assist sensor) in order to be legal for street operation. This means that the motor will provide assistive power only if the rider is pedaling. If the rider stops pedaling, the motor must also stop.

An illustrative example of a pedal assist sensor of the present invention is shown in FIGS. 8 and 9. It should be noted that while the PAS of the present invention is described herein with regard to use with an electrical power assist motor, this is not intended to be viewed as a limitation of the present invention and that use of the PAS of the present invention with substantially an power assisted vehicle having substantially any suitable propulsion system is within the scope of the present invention.

The PAS of the present invention is configured as a small sensor 60 (illustrated in FIGS. 2A and 2B) that is attached to either one of the pedal crank arms 102. Preferably, the PAS 60 of the present invention is mounted on the back side of one of the crank arms away from the rider's foot, as illustrated in FIGS. 2A and 2B.

The PAS sensor 60 of the present invention may be attached to the crank arm 102 by any of a number of attachment arrangements known such as, but not limited to, Velcro™ or zip-tie, as mentioned above.

As illustrated in the schematic block drawing of FIG. 9, the PAS 60 of the present invention includes an accelerometer 62, a processing chip 64, transmitter 68, with an antenna 69, and a small watch battery 70. The transmitter 68 is preferably, but not necessarily, a 2.4 GHz RF transmitter. Due to the simplicity of the PAS 60 of the present invention, the life expectancy of the battery is more than 2 years.

The accelerometer 62 is configured to detect both motion and direction. Therefore, in operation, when the accelerometer 62 detects that the pedals are moving in a direction that indicates that the crank shaft and front sprocket are turning in the proper direction for forward movement of the bicycle 100, the RF transmitter 68 sends a command signal to the motor control system to start the power assist operation of the motor 10.

When the accelerometer 62 detects that movement of the pedals in the proper direction has stopped or that the pedal movement is in the wrong direction, it sends a command signal to stop the power assist operation of the motor 10.

It will be appreciated that the PAS 60 of the present invention may be used in a system that does not include a throttle such as the throttle mentioned above. In such an installation, the forward movement of the pedal crank 102 would cause the PAS 60 to send a “start” signal to the motor 10. The motor 10 in turn would run “full on” until receiving a “stop” signal from the PAS 60.

Alternatively, the PAS 60 of the present invention may be configured such that the accelerometer 62 detects the speed at which the pedal crank 102 is turning and that data is sent to the motor controller 24, which in turn varies the speed of the motor based on the speed at which the pedal crank 102 is turning.

It will be understood that in such a system, an “on-off” switch would be redundant and therefore unnecessary since the mere act of turning the pedals brings the motor to a “run” state and stopping pedaling brings the motor to an “off” state.

The simplicity of both the operation and installation of the PAS of the present invention make it suitable for installation with new power assist drive systems and for retrofit installation with existing power assist drive systems that have already been installed on a vehicle.

European regulation also requires that the temperature of the batteries of electrical power assist systems be monitored and shut down if they overheat. In order to comply with this regulation, the present invention includes a battery monitoring system which may be incorporated into the control board or configured as a separate unit.

The batteries 22 of the present invention are deployed as separate units in each of the spokes 8. This is quite different from the battery packs in currently in common use in the art, in which all the batteries a included in a single battery pack that is treated by the system as a single unit.

Such an arrangement is a definite advantage for the present invention in that should a battery malfunction occur, only the malfunctioning battery or batteries need be changed. This arrangement, however, requires that each battery 22 be individually monitored by the battery monitoring system.

To that end, the battery monitoring system of the present invention is configured to monitor the temperature, output and input of each battery individually. Thusly configured, the battery monitoring system is capable of shutting down (i.e., disconnect from the system) any single battery or plurality of batteries that malfunction during both operational and recharging conditions.

By providing the ability to change only one battery 22, the battery monitoring system of the present invention is capable of adapting to include batteries of differing charge levels and rates. A non-limiting theoretical example of the feature may be the replacement of only one battery when all batteries in the system are at a 40% charge level. The new battery being installed will have a charge level that is close to 100%. This scenario presents both power operation and recharging issues. During power operation, the system regulates each battery 22 individually and maintains the appropriate electrical draw rate from each battery. Similarly, during charging, each battery 22 is monitored so as to be charged at an appropriate rate and to its correct level without over charging. In the situation above the new battery would most likely reach a full recharge sooner than the old batteries, therefore, the battery monitoring system of the present invention would discontinue charging to the new battery while continuing to charge the ole batteries until each is fully charged.

Therefore, the present invention provides a method for monitoring a plurality of individual batteries in an electric power assist system for use with a pedal vehicle by individually monitoring the battery temperature, battery output and battery intake (charge) for each battery in the electric power assist system. Disconnecting from the electric power assist system any individual battery that experiences a malfunction while maintaining operational connection to any of the individual batteries in the electric power assist system that is functional.

This is accomplished by providing a battery monitoring system configured to monitor each of the individual batteries in the electric power assist system as an independent entity; and controlling each individual battery based on a current operational status of that individual battery.

Such a control system allows operation of the electric power assist system when the current operational status of different ones of the individual batteries in the electric power assist system indicates that different ones of the individual batteries have differing charge levels.

It will be appreciated that the above descriptions are intended only to serve as examples and that many other embodiments are possible within the spirit and the scope of the present invention.

What is claimed is:

1. A wireless pedal assist sensor for use with a power assisted pedal vehicle, the pedal assist sensor comprising:
(a) a processing chip;
(b) an accelerometer in electrical communication with said processing chip;
(c) transmitter in electrical communication with said processing chip;
(d) an antenna connected to said transmitter; and
(e) a battery;
wherein when said accelerometer detects that the pedals of the pedal vehicle are moving in a direction that indicates forward movement of the pedal vehicle, said transmitter send a command signal to a motor control system to start power assist operation, and when said accelerometer detects that movement of the pedals has stopped or that the pedal movement is in a wrong direction, said transmitter sends a command signal to stop the power assist operation.

2. The wireless pedal assist sensor of claim 1, wherein said transmitter is a 2.4 GHz RF transmitter.

3. The wireless pedal assist sensor of claim 1, wherein said accelerometer is configured to detect both motion and direction.
